(19) United States
(12) Patent Application Publication
(10) Pub. No.: US 2006/0037916 A1
(43) Pub. Date: Feb. 23, 2006

(54) Apparatus for separating dispersed particles

(76) Inventor: Felix Trampler, Hinterbruhl (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/206,105

(22) Filed: Aug. 18, 2005

(30) Foreign Application Priority Data
Aug. 19, 2004 (AT) A 1402/2004

(51) Int. Cl. C02F 1/32

(52) U.S. Cl. 210/748

(57) ABSTRACT

The invention relates to an apparatus for separating dispersed particles or similar particles (4), comprising a separating vessel (1) which is provided with at least one transducer (2) for generating ultrasonic waves in the form of a wave with substantially perpendicularly extending oscillation node surfaces, an inlet opening (3) for the dispersion, an outlet opening (6) for the liquid medium and a discharge opening (5) for the separated particles. An effective separation can be achieved in such a way that the separating vessel (1) contains a separating surface (7, 8, 9) which is inclined at an acute angle (α) relative to the horizontal in the used position.

### FIELD OF THE INVENTION

The invention relates to an apparatus for separating dispersed particles or similar particles, comprising a separating vessel which is provided with at least one transducer for generating ultrasonic waves in the form of a wave with substantially perpendicularly extending oscillation node surfaces, an inlet opening for the dispersion, an outlet opening for the liquid medium and a discharge opening for the separated particles.

Particles are also included within the terms of the invention which are not particles per se, but act analogously with respect to separation. These are oil droplets for example in colloidal form or gas bubbles.

### PRIOR ART

It is known that solids from dispersions can be separated by sedimentation. The separation rate is smaller the lower the difference in density of the solids in comparison with the liquid media and the smaller the particle size. Methods are known from EP 0 400 115 A and from EP 0 633 049 A which agglomerate particles in the dispersion by ultrasonic waves and thus achieve a higher separation rate. Separation methods of this kind are suitable for problems to be solved in biotechnology where it is necessary to separate cells from liquid media. Apparatuses are operated in this field in flow-through, comprising a cleaning chamber in which a mostly standing ultrasonic wave is formed which holds back the solid particles by the influence of gravity in the upwardly flowing dispersion and condenses the same until sedimentation capability is reached. The sedimentation occurs against the direction of flow, thus having a disadvantageous influence on the separation rate especially at higher particle flow rates.

Moreover, so-called inclined plate separators are known in which inclined surfaces are used to accelerate the sedimentation. Such inclined plate separators are only effective within limits for particles with small diameters and/or low differences in density.

DE 42 30 482 A describes an apparatus for separating dispersions, especially for drying steam vapors, comprising a horizontally lying acoustic irradiation chamber. This apparatus is also not effective under the aforementioned unfavorable application conditions.

### SHORT DESCRIPTION OF THE INVENTION

It is the object of the present invention to provide an apparatus which avoids the above disadvantages and provides an increased separating output.

These objects are achieved in accordance with the invention in such a way that the separating vessel contains a separating surface which is inclined at an acute angle α relative to the horizontal in the position of use. An especially advantageous effect was surprisingly obtained by the combination of agglomeration by the ultrasonic field with the specific geometry of the separating vessel. The separated particles slide along the inclined floor representative of the separating surface downwardly towards the discharge opening.

It is especially advantageous when the floor has an ascending angle of between 15° and 75°, preferably between 30° and 60°. Optimal separating results are thus achieved.

Especially advantageous flow conditions in the interior of the separating vessel can be achieved in such a way that the inlet opening is arranged above the discharge opening. The shearing flow thus obtained promotes the gravitational separation of particles with a higher density than that of the liquid phase.

### SHORT DESCRIPTION OF THE DRAWINGS

The present invention is explained in closer detail below by reference to embodiments shown in the drawings, wherein:

FIG. 1 shows a sectional view of a first embodiment of the invention, and

FIG. 2 and FIG. 3 show further embodiments.

### DETAILED DESCRIPTION OF PREFERRED EMBODIMENTS

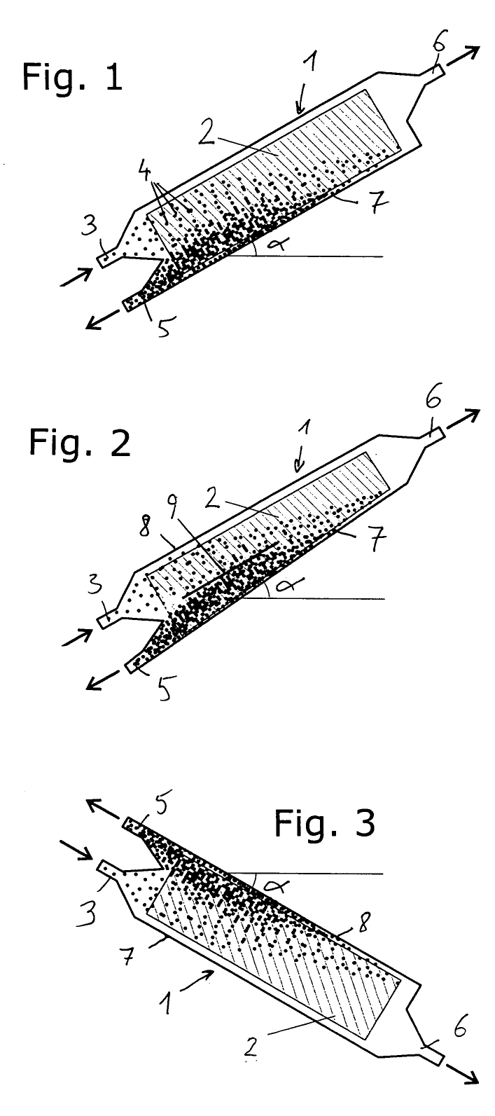

In the embodiment of FIG. 1, a separating vessel 1 is provided with a transducer 2 which is arranged on a side wall. The side wall which is not visible in the figures and is parallel opposite either also carries a transducer operated with the same frequency or it acts as an acoustic reflector in order to build up a standing ultrasonic field in the interior of the separating vessel 1. A dispersion to be cleaned is supplied through an inlet opening 3 and is agglomerated in the interior of separating vessel 1 by the sound field, so that separation is promoted by gravity. In the embodiment of FIG. 1, solids particles are separated from a dispersion which have a higher density than the liquid medium. The solids particles are designated with excessive size with reference numeral 4. It can be seen that the solids particles 4 accumulate in a downward direction and can be drawn off through a discharge opening 5. The liquid phase freed from the particles 4 can be drawn off via the outlet opening 6. The floor 7 of the separating vessel 1 is formed in the embodiments of FIG. 1 and FIG. 2 as a separating surface on which local gradients of the particle concentration form which promote the separation. The floor 7 is inclined at an angle α of approximately 30° to the horizontal in order to enable overcoming frictional forces, so that the solids particles 4 move towards the discharge opening 5.

The embodiment of FIG. 2 differs from FIG. 1 in such a way that the cover surface 8 is slightly inclined relative to floor 7, thus leading to a tapering of the separating vessel 1 towards the outlet opening 6. Swirls in the transitional region between the inlet opening 3 and the discharge opening 5 caused as a result of the increased flow cross section can be reduced in this manner. Moreover, a further inner separating surface 9 is provided in the embodiment of FIG. 2 in the interior of the separating vessel, which further surface is formed essentially parallel to the floor 7 and extends over a part of the length of the separating container 1. If required, several such inner separating surfaces 9 can be provided above one another in order to increase the effect. Several analogously arranged inlet and outlet openings (not shown) can optionally be provided.

The embodiment of FIG. 3 differs from the above embodiments in such a way that the separating surface is formed on the cover surface 8 in order to enable the separation of particles whose density is lower than that of the liquid phase. These could be oil droplets or gas bubbles for example. Accordingly, the separating vessel 1 is downwardly inclined at an angle α, and the inlet opening 3 lies below the discharge opening 5.

The present invention allows performing an effective separation of different particles through a combined effect of inclined surfaces and an ultrasonic field.

1. An apparatus for separating dispersed particles or similar particles, comprising a separating vessel which is provided with at least one transducer for generating ultrasonic waves in the form of a wave with substantially perpendicularly extending oscillation node surfaces, an inlet opening for the dispersion, an outlet opening for the liquid medium and a discharge opening for the separated particles, wherein the separating vessel contains a separating surface which is inclined at an acute angle α relative to the horizontal in the position of use.

2. An apparatus according to claim 1, wherein the separating surface has an angle α of between 15° and 75°.

3. An apparatus according to claim 1, wherein the separating surface has an angle α of between 30° and 60°

4. An apparatus according to claim 1, wherein the inlet opening is arranged above the discharge opening.

5. An apparatus according to claim 1, wherein the inlet opening is arranged below the discharge opening.

6. An apparatus according to claim 1, wherein the separating vessel comprises two essentially parallel side walls, of which at least one carries a transducer.

7. An apparatus according to claim 1, wherein further separating surfaces are provided in the interior of the separating vessel.
